(19) United States
(12) Patent Application Publication
(10) Pub. No.: US 2026/0351640 A1
(43) Pub. Date: Nov. 5, 2026

(54) DEVICE FOR PRODUCING ELECTRICITY

(71) Applicants: PARIS SCIENCES ET LETTRES, PARIS (FR); ECOLE SUPERIEURE DE PHYSIQUE ET DE CHIMIE INDUSTRIELLES DE LA VILLE DE PARIS, PARIS (FR); CENTRE NATIONAL DE LA RECHERCHE SCIENTIFIQUE, PARIS (FR)

(72) Inventors: Annie COLIN, PARIS (FR); Youcef BRAHMI, PARIS (FR); Nan WU, PARIS (FR)

(73) Assignees: PARIS SCIENCES ET LETTRES, PARIS (FR); ECOLE SUPERIEURE DE PHYSIQUE ET DE CHIMIE INDUSTRIELLES DE LA VILLE DE PARIS, PARIS (FR); CENTRE NATIONAL DE LA RECHERCHE SCIENTIFIQUE, PARIS (FR)

(21) Appl. No.: 19/485,701

(22) PCT Filed: May 28, 2024
(86) PCT No.: PCT/EP2024/064685

§ 371 Date: Nov. 19, 2025

(30) Foreign Application Priority Data
May 29, 2023 (FR) FR2305308

(51) Int. Cl. H01M 8/08

(52) U.S. Cl. CPC H01M 8/08

(57) ABSTRACT

A device for producing electricity includes a cell having two compartments. Each compartment has a surface for adsorbing a predetermined ion, and the two compartments are separated by a membrane that is porous to at least the predetermined ion. The two compartments are each intended to receive a liquid (L1, L2) having different concentrations of the predetermined ion. The cell includes two terminals respectively connected to the adsorption surfaces of the two compartments, of the cell creating a difference in potential Eocv across its two terminals in the presence of the respective liquids. A voltage generator has two terminals, one connected to a terminal of the cell, the generator producing a difference in potential E0 across its two terminals; the other terminal of the generator constitutes one terminal, and the other terminal is the other terminal of the cell.

### TECHNICAL FIELD

The present invention concerns the field of renewable energies and, in particular, producing electricity.

The present invention relates in particular to blue energy, that is the recovery of energy from the change in Gibbs free energy of a system by combining two solutions having different concentrations of the same ionic species.

A widespread application in this field is to exploit the difference in salinity between a mixture of fresh and sea water.

### BACKGROUND

The method known as “pressure retarded osmosis” is known from the prior art. This technique is based on the phenomenon of osmosis. In practice, this technique is based on the diffusion of water molecules from a compartment containing fresh water to another compartment containing salt water, through a semi-permeable membrane separating the two compartments. This mass transfer increases the amount of liquid present in the saltwater compartment, generating a hydrostatic pressure difference between the two compartments, which in turn generates usable hydraulic energy.

Reverse electrodialysis and capacitive mixing are also known. These techniques aim to harness the energy generated by ion diffusion induced by the difference in salinity of solutions separated by a selective membrane. Faradic electrodes, in the case of reverse electrodialysis, and capacitive electrodes, in the case of capacitive mixing, are immersed in the solutions and convert the ion flow into an electric current.

In electrodyalysis, the cell comprises a series of compartments separated from each other by a membrane porous to anions or cations. It is the successive and selective diffusion of ions and anions through the compartments that generates the recovered current.

In the case of capacitive mixing, the recovered current is generated by the successive, alternating filling of the cell's two compartments with a solution concentrated in a given ion and then with a solution with a low concentration of that given ion.

One of the major challenges for all these techniques lies in improving the efficiency of the energy produced and, in the case of electricity generation, power density.

A further aim of the invention is to provide a device for producing electricity:
to recover more energy from systems consisting of the combination of two solutions with different concentrations of an ionic species,
whose power density is higher than that produced by prior art devices.

### SUMMARY

For this purpose, a device for producing electricity is proposed, referred to as device, comprising a cell. The cell comprises two compartments. Each compartment comprises an adsorption surface for one or more predetermined ions, and said two compartments are separated by a membrane porous to at least the predetermined ion. The two compartments are each designed to receive a liquid with a different concentration of the predetermined ion. The cell comprises two terminals respectively connected to the adsorption surfaces of the two compartments. The cell is able to generate a potential difference E_{ocv} between its two terminals in the presence of the respective liquids in the two compartments.

The device further comprises a voltage generator, referred to as generator. The device further comprises two terminals. The generator comprises two terminals. One of the two generator terminals is connected to one of the two cell terminals, the other of the two generator terminals is one device terminal, and the other of the two device terminals is the other cell terminal. The generator is arranged to deliver a potential difference E₀ between its two terminals.

The device may comprise a control unit arranged and/or programmed and/or configured to control and/or monitor the generator and/or means for supplying the device with power and/or the cell.

Preferably, the liquids intended to fill the compartments comprise multiple ions, for example at least one anion and at least one cation. Preferably, the liquids comprise multiple ions including the predetermined ion.

Preferably, the membrane is porous to ensure or enable ion exchange between the compartments and/or to ensure or enable the circulation or conduction of electric current in, and/or through, the cell and/or compartments.

Preferably:
the cell terminal to which the generator terminal is connected constitutes the negative polarity terminal of the cell and the generator is arranged, or the control unit is arranged and/or programmed and/or configured, so that said generator terminal connected to the cell terminal constitutes the positive polarity terminal of the generator, and/or
the cell terminal to which the generator terminal is connected constitutes the positive polarity terminal of the cell and the generator is arranged, or the control unit is arranged and/or programmed and/or configured, so that said generator terminal connected to the cell terminal constitutes the negative polarity terminal of the generator.

Preferably, a sign of the potential difference E₀ applied across the generator, that is a sign of the voltage E₀=V₇₁−V₇₂, is identical to the sign of the potential difference E_{ocv} generated across the cell, that is a sign of the voltage E_{ocv}=V₆₁−V₆₂.

Preferably, the potential difference E_{dis} across the device, that is voltage E_{dis}=V₈₁−V₈₂=V₆₁−V₇₂, is equal to the sum of the potential difference E_{ocv} across the cell, in the presence of the respective liquids in the two compartments, and the potential difference E₀ across the generator, that is E_{dis}=E_{ocv}+E₀.

Preferably, the generator is arranged to, or the control unit is arranged and/or programmed and/or configured to, switch and/or adapt and/or select the polarity of its terminals so that the generator terminal connected to the cell terminal is of opposite polarity to the cell terminal to which it is connected.

Preferably, the predetermined ion adsorption surfaces are layers porous to the liquids that the two compartments are intended to receive.

Preferably, each compartment comprises an electrode, an external surface of which constitutes the adsorption surface for the at least one predetermined ion.

The outer surface of the electrode can be defined as the surface of the electrode that is intended to come into contact with the liquid(s).

The electrode of one of the two compartments may be different, or made of the same material, as the electrode of the other of the two compartments. Preferably, the electrodes in each compartment are identical or made of the same material.

Preferably, the electrode of one compartment, or each electrode of each compartment, is a capacitive electrode.

Preferably, the membrane is porous only to the predetermined ion.

Preferably, the adsorption surfaces are specific to the predetermined ion. Preferably, the adsorption surfaces are specific to the predetermined ion so that only the predetermined ion adsorbs on the adsorption surfaces, or the predetermined ion is the ion predominantly adsorbed on the adsorption surfaces.

Adsorption surfaces can be non-specific to the predetermined ion. The adsorption surfaces can be non-specific so that one or more ions, other than the predetermined ion, contained in the liquids to be received in the compartments adsorb onto the adsorption surfaces.

The porous membrane can be a selective membrane or a non-selective membrane.

Preferably, the porous membrane is a selective membrane. Preferably, the porous membrane is arranged so that only the predetermined ion diffuses or passes through the selective membrane. Preferably, the porous membrane is a selective ionic membrane. Preferably, the selective membrane is porous to one type of ion, preferably to only one type of ion, for example to anions or cations, or even more preferably to one type of cation or one type of anion. Preferably, the selective membrane is porous to a predetermined type of ion. Preferably, the selective membrane is impermeable to ions other than the predetermined ion type and to molecules (ionic or not), in particular to molecules constituting the liquid(s). Preferably, the at least one predetermined ion belongs to the predetermined ion type.

Preferably, the selective membrane is porous to cations or anions. Preferably, the selective membrane is porous to a single type of cation, for example sodium ions (Na⁺), potassium ions (K⁺) or protons (or hydronium ions), or to a single type of anion, for example chloride ions (Cl⁻), hydroxide ions (OH⁻), bromide ions (Br⁻), sulfate ions (SO₄²⁻) or nitrate ions (NO₃⁻). In the present application, protons or hydronium ions are considered cations.

Preferably, the generator is arranged to deliver a non-zero potential difference E₀. Preferably, the generator is arranged to deliver a potential difference E₀ lower than the absolute value of a redox potential, V_{redox,s}, of the liquids, preferably than a redox potential V_{redox,s} of the solvent molecule constituting the liquids, and/or the absolute value of a redox potential, V_{redox,i}, of the at least one predetermined ion and/or the absolute value of a redox potential of each of the ions contained in the liquids (L1, L2).

The absolute value of the redox potential V_{redox,s} can be defined as the potential above which electrolysis of the liquid solvent is initiated. The absolute value of the redox potential of a given ion can be defined as the potential above which oxidation or reduction occurs.

Preferably, the generator is arranged to deliver a potential difference E₀ of less than 5 Volts, preferably 4 Volts, more preferably 3 Volts and even more preferably 2 Volts.

Preferably, the generator is arranged to apply an alternating potential difference E₀.

Preferably, the alternating potential difference E₀ is periodic. Preferably, a period of the periodic alternating potential difference E₀ is greater than or equal to 10 seconds.

Preferably, the period of the alternating potential difference E₀ is adapted and/or synchronized and/or equal to a saturation or loading time of the generator, in particular of the adsorption surfaces. The saturation or loading time of the generator or adsorption surfaces can be taken to mean the time between the liquids coming into contact with their respective compartments and the saturation of the ion adsorption surfaces with ions, in particular the predetermined ion.

Preferably, the polarity of the cell terminals is reversed after each cell discharge. Cell discharge can be taken to mean the flow of current, for example through an electrical resistor connected to the terminals of the electricity-generating device, generated by closing an electrical circuit comprising the electricity-generating device.

The voltage can vary, for example linearly, over one or more periods. Preferably, the voltage E₀ is constant during each period, that is the periodic AC voltage E₀ applied corresponds to or is a rectangular signal.

Preferably, the device comprises supply means arranged to supply the compartments with liquid(s). Preferably, the supply means are arranged to supply one of the two compartments with liquid having a concentration C1 of the predetermined ion and the other of the two compartments with liquid having a concentration C2, lower than C1, of the predetermined ion, and vice versa.

Preferably, the supply means are arranged to feed L1 and L2 solutions successively to each of the compartments.

Preferably, the supply means are arranged to:
inject solution L1, or respectively L2, into one of the compartments and inject solution L2, or respectively L1, into the other compartment, then
after a given time interval, inject solution L2, or respectively L1, into said compartment and inject solution L1, or respectively L2, into the other of the compartments.

Preferably, a period between two successive liquid supplies to the compartments is equal to the period of the AC potential difference E₀ applied by the generator.

Preferably, the device, or the generator and/or the control means and/or the cell and/or the processing unit, is arranged to introduce a phase shift between the successive liquid supplies to the compartments, in other words between the successive injections of liquids L1 and L2 into the compartments, and the periodic alternating signal of the voltage E₀ applied by the generator.

Preferably, the device comprises at least two cells connected serially.

The at least two serially-connected cells can be defined as a series-connected cell assembly.

Preferably, when the device comprises at least two cells in series, the generator is arranged to deliver a potential difference E₀ greater than or equal to the sum of the voltages E_{ocv} generated across the cells in the presence of the respective liquids in the cell compartments.

Preferably, when the device comprises at least two cells in series, the generator is arranged to deliver a potential difference E₀ of less than:
a potential, V_{app,s}, equal to the product of the redox potential of the liquids V_{redox,s} and the number of cells in series, denoted n, forming the device, that is V_{app,s}=n×V_{redox,s}, and/or
a potential, denoted V_{app,i}, equal to the product of the redox potential of the at least one V_{redox,i} ion predetermined by the number of cells in series, denoted n, forming the device, that is V_{app,i}=n×V_{redox,i}.

Preferably, when the device comprises at least two cells in series, the device comprises individual power supply means for each cell.

Preferably, when the device comprises at least two cells in series, one of the two terminals of the generator is connected to one of the two terminals of the series cell assembly, the other of the two terminals of the generator constitutes the second terminal of the device and the other of the two terminals of the series cell assembly constitutes the second terminal of the device.

Preferably, an electricity generation process is also proposed comprising the steps of:
generating a potential difference between two terminals of a cell comprising two compartments from a difference in concentration of a predetermined ion between two liquids each contained or intended to be contained, in one of the two respective compartments; each compartment comprises an adsorption surface for the predetermined ion, the two terminals of the cell are respectively connected to the adsorption surfaces of the two compartments and said two compartments are separated by a membrane porous to at least the predetermined ion,
applying, by means of a voltage generator, denoted generator, a potential difference E₀ between the two terminals of the voltage generator; one terminal of the generator is connected to one of the two terminals of the cell, the other terminal of the generator constitutes one of the two terminals of the device for producing electricity, comprising the cell and the generator, and the other terminal of the device is constituted by the other terminal of the cell.

Preferably, the device for producing electricity according to the invention is suitable, more preferably is particularly suitable, more preferably is designed and particularly advantageously is specially designed, for implementing the method for producing electricity according to the invention. Thus, any feature of the device for producing electricity according to the invention can be directly transposed and integrated into the method for producing electricity according to the invention, and vice versa.

### BRIEF DESCRIPTION OF FIGURES

Other benefits and features shall become evident upon examining the detailed description of entirely non-limiting embodiments and implementations, and from the following enclosed drawings:

FIG. 1 is a schematic side-view representation of an embodiment of a device for producing electricity according to the invention at the end of the injection of liquids L1, L2 into their respective compartments during a given period,

FIG. 2 is a schematic representation in side view of an embodiment of a power generation device according to the invention at the end of the injection of liquids L1, L2 into their respective compartments during a period succeeding a period as shown in FIG. 1,

FIG. 3 is a graph showing the curves, obtained by chronovoltammetry, of the voltage E_{load} across the external resistor R_{load}, in solid lines, for several potential differences E₀, in dotted lines, delivered by the generator over multiple successive periods,

FIG. 4 is a graph showing the net power density versus R_{load} curves obtained by the cell, denoted P_{nb}, and the net power density versus R_{load} curves obtained by the device for producing electricity, denoted P_{b-net}, for a potential difference E₀ delivered by the generator of 550 mV,

FIG. 5 is a histogram showing the net power densities P_{nb} supplied by the cell and the net power densities P_{b-net} supplied by the device for multiple potential differences E₀ delivered by the generator,

FIG. 6 is a graph showing the net power density versus R_{load} curves obtained by the cell 2, denoted P_{nb}, and the net power density versus R_{load} curves obtained by the device for producing electricity, denoted P_{b-net}, for a multiple potential differences E₀ delivered by the generator,

FIG. 7 is a graph showing the net power density versus R_{load} curves obtained by the cell 2, denoted P_{nb}, and the net power density versus R_{load} curves obtained by the device for producing electricity, denoted P_{b-net}, for multiple potential differences E₀ delivered by the generator,

FIG. 8 is a schematic side-view representation of an improvement to the embodiment of a device for producing electricity according to the invention at the end of the injection of liquids L1, L2 into their respective compartments 31, 32 during a given period,

FIG. 9 is a graph showing the net power density curve, denoted P_{b-net}, as a function of R_{load} obtained by the power generation device according to the improvement shown in FIG. 8 for a potential difference E₀ delivered by the generator of 0 mV.

### DETAILED DESCRIPTION

The embodiments described below are in no way limiting, and in particular, it is possible to consider variants of the invention that comprise only a selection of the features disclosed, in isolation from the other features disclosed (even if that selection is isolated within a phrase comprising other features), if this selection of features is sufficient to confer a technical benefit or to differentiate the invention with respect to the prior state of the art. This selection comprises at least one preferably functional feature which lacks structural detail, or only has a portion of the structural details if that portion only is sufficient to confer a technical benefit or to differentiate the invention with respect to the prior state of the art.

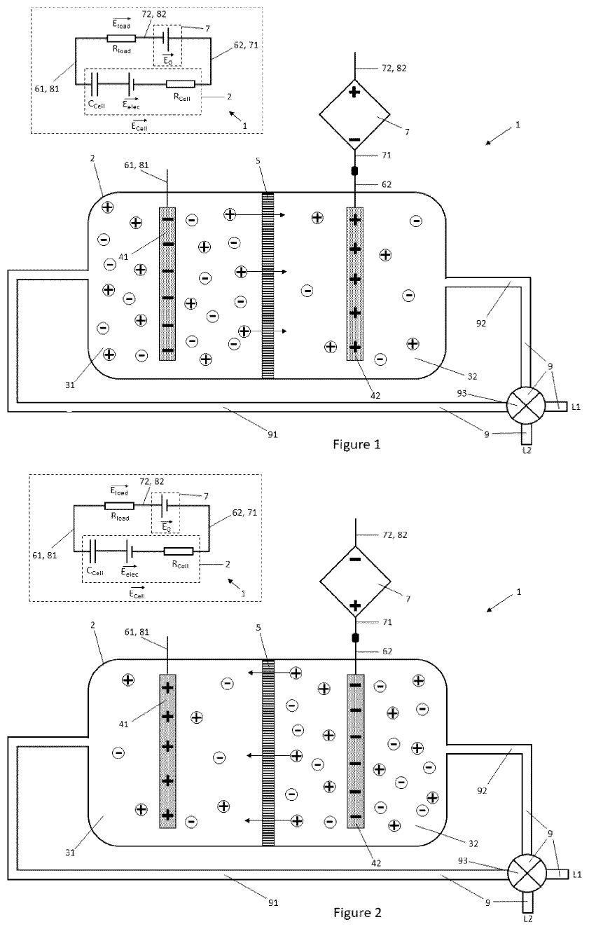

With reference to FIGS. 1 and 2, an embodiment of the device for producing electricity 1 according to the invention is presented. The device 1 comprises a cell 2. The cell 2 comprises two compartments 31, 32. Each compartment 31, 32 comprises an adsorption surface 41, 42 for a predetermined ion. The two compartments 31, 32 are separated by a porous membrane 5 with at least one predetermined ion. The two compartments 31, 32 are each intended to receive a liquid L1, L2 with a different concentration of the predetermined ion. The cell 2 comprises two terminals 61, 62 respectively connected to the adsorption surfaces 41, 42 of the two compartments 31, 32. The cell 2 is able to generate a potential difference E_{ocv} between its two terminals 61, 62 in the presence of the respective liquids L1, L2 in the two compartments 31, 32. The device 1 comprises a voltage generator 7. The generator 7 comprises two terminals 71, 72. One terminal 71 of the generator 7 is connected to the terminal 62 of the cell 2, and the other terminal 72 of the generator 7 forms a terminal 82 of the device 1. The other terminal 81 of the device 1 is the other terminal 61 of the cell 2. The generator 7 is arranged to deliver a non-zero potential difference E₀ between its two terminals 71, 72.

The cell 2 is a capacitive salinity gradient cell. Also, when the cell 2 is open-circuited, the contact of two liquids L1, L2, of which a predetermined ion is of different concentration, with the two respective adsorption surfaces 41, 42, for example the liquid L1 in contact with the adsorption surface 41 and liquid L2 in contact with the adsorption surface 42, will result in the appearance of a potential difference at the terminals 61, 62 of cell 2. This is due to the selective diffusion of the at least one ion through the membrane 2, which generates a difference in salinity between the two compartments 31, 32, and to a different variation in the potential of one electrode 41, 42 compared to the other 42, 41 due to the variation in the concentration of the at least one ion in the compartments 31, 32. Closing the circuit, that is, connecting the terminals 61, 62 of the cell 2 to the terminals of a resistor, will cause a current to flow through the resistor and a drop in the capacitive potential difference between the two adsorption surfaces 41, 42 and therefore across the terminals of the cell 2. The current generated will therefore decrease as the potential difference across cell 2 decreases. At this point, when cell 2 is “discharged”, the liquids L1, L2 are removed from their respective compartments 31, 32. The liquid L1 is then placed in compartment 32 and the liquid L2 is placed in the compartment 31 to initiate a new cycle (or period). In this way, a current can be recovered periodically from the cell 2 by successive injections and withdrawals of liquids L1, L2 into the compartments 31, 32. In the present application, the period T of the cell 2 or device 1 is taken to mean the time between two successive injections of liquids L1, L2 into compartments 31, 32; that is, injection of liquid L1 into compartment 31 and injection of liquid L2 into compartment 32, during a period T under consideration, followed by injection of liquid L1 into compartment 32 and injection of liquid L2 into compartment 31, during a period T+1 succeeding the period T under consideration, and vice versa. FIG. 1 shows the state of the device 1 at the end of injection of liquids L1, L2 into their respective compartments 31, 32 during a given period T. FIG. 2 shows the state of the device 1 at the end of injection of the liquids L1, L2 into their respective compartments 31, 32 during a period T+1 following the period T under consideration. The phase difference, or phase shift, between the period of cell 2 and the period of the voltage supplied by generator 7 is as small as possible, ideally equal to zero.

According to the embodiment, means 9 for supplying the compartments with liquids L1, L2 are shown. However, these supply means 9 are known and are not part of the device 1. The cell 2 is only able to cooperate with these supply means 9, which are intended to be mounted on the cell 2. The supply means 9 comprise two circuits 91, 92 respectively connecting compartments 31, 32 to a changeover means 93, for example a pneumatic valve 93, arranged to control the injection of liquids L1, L2 into one of circuits 91, 92. The supply means 9 comprise a pump arranged to regulate and control the injection rate of liquids L1, L2 into circuits 91, 92.

According to a first non-limiting embodiment, the solutions used to show the operation and performance of the device 1 according to the invention are aqueous solutions L1, L2 comprising Sodium Chloride NaCl at two different concentrations. The operation of the device 1 is therefore based on a difference in the concentration of a predetermined ion, sodium Nat or chloride Cl⁻ ions in the first embodiment, in the two liquids L1, L2. According to this first embodiment, in practice and for the intended applications, the two liquids envisaged for use in salinity gradient capacitive cells are seawater and freshwater, in order to exploit their difference in salinity. The membrane 5 is a sulfonated tetrafluoroethylene or NAFION™ cationic ion exchange membrane, of the model NAFION™ 117, sold by Chemours®, with a thickness of 183 μm in its dry form. The adsorption surfaces 41, 42 are made of carbon felt, have a geometric surface area of approx. 2.2 cm² and are 1.5 mm apart. Two graphite current collectors are connected to the adsorption surfaces 41, 42 respectively. Each compartment 31, 32 has a volume of approximately 0.34 cm³. Adsorption surfaces 41, 42 made of carbon felt act as capacitive electrodes. A ratio of fifty between NaCl concentrations in liquids L1 and L2 was used, with liquid L1 having an NaCl concentration of 5.13 mol/L and liquid L2 having a concentration of 0.17 mol/L. The filling rate of compartments 31, 32 is 10 mL/min according to the first method. FIG. 1 shows the start of a period T when the liquid L1 with the highest concentration is being injected into the compartment 31, at which point the Na⁺ cations have not diffused through membrane 5. FIG. 2 shows the start of a period T when the liquid L1 with the highest concentration is being injected into the compartment 32, at which point the Na⁺ cations have not diffused through the membrane 5. The dotted inserts in FIGS. 1 and 2 show the equivalent circuit of the cell 2 as it discharges into the external resistor, denoted R_{load}. The equivalent circuit of cell 2 comprises an internal resistance R_{cell} and a capacitance C_{cell}. The potential difference E_{cell} at the terminals 61, 62 of the cell 2 is equal to the sum of the Donnan potential generated by the membrane 5 and the potential between adsorption surfaces 41, 42, minus the potential drop induced by the capacitance C_{cell} of cell 2. When cell 2 is open-circuited, the open-circuit potential, denoted E_{ocv}, of the cell 2 is approximately 144 millivolts (mV), the resistance R_{cell} of the cell 2 is approximately 5.39 ohms (Ω) and the capacitance C_{cell} of the cell 2 is approximately 1.27 Farads (F).

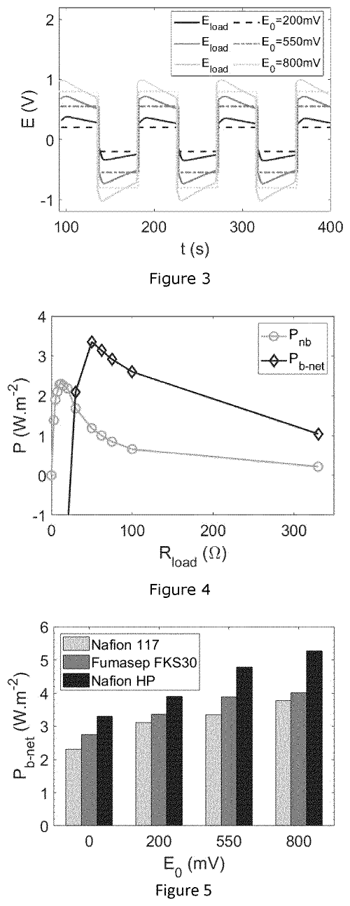

The graph in FIG. 3 shows the curves resulting from chronovoltammetry measurements of the voltage E_{load} across the external resistor Road, in solid lines, for several potential differences E₀, in dotted lines, delivered by generator 7, for a load resistor R_{load} set at 75Ω and for several successive periods T, each lasting 45 seconds.

The graph in FIG. 4 shows the net power density versus R_{load} curves obtained by cell 2, denoted P_{nb}, used alone (without generator 7), and the net power density versus R_{load} curves obtained by device 1, denoted P_{b-net}, for a potential difference E₀ delivered by generator 7 of 550 mV. In the present description, the net power density P_{nb} supplied by cell 2 corresponds to the power produced by cell 2 used alone (without generator 7) and the net power density P_{b-net} supplied by device 1 according to the invention as shown in FIGS. 1, 2 and 8. In the case of cell 2, the net power density P_{nb} is the power density dissipated in the external resistor R_{load}. In the case of device 1, the net power density P_{b-net} is calculated as the difference between the power density dissipated by the device 1 in the external resistor R_{load} over the discharge time and the power density supplied by the generator 7 over the discharge time. Surprisingly, for external resistance values R_{load} greater than 30 Ohms, the net power density P_{b-net} of device 1 is greater than the net power density P_{nb} of cell 2. In other words, the net power density P_{b-net} supplied by device 1 is greater than the sum of the net power density P_{b-net} supplied by cell 2 during discharge and the power density supplied by generator 7 during discharge. The device 1 achieves a maximum net power density of 3.35 W·m⁻², corresponding to a 45.4% increase over the maximum net power density achieved by the cell 2.

Tables 1, 2 and 3 show the comparative results, in terms of gain, between device 1 and cell 2. Gain is expressed in percent and corresponds to the ratio between (i) the difference between the net power density P_{b-net} supplied by device 1 and the net power density P_{nb} supplied by cell 2 and (ii) the net power density P_{nb} supplied by cell 2, that is Gain=(P_{b-net}−P_{nb})/P_{nb}. The net power densities supplied by device 1 and cell 2 were measured for multiple differences in NaCl concentration in liquids L1, L2 and for several periods T. The net power density P_{b-net} supplied by device 1 was also measured for multiple potential differences E₀ delivered by generator 7, and for each potential difference E₀ considered, the external resistance R_{load} that gave optimum results, denoted Rₘₐₓ, was used. The results shown in Table 1 were obtained with a device 1 comprising a NAFION™ 117 membrane 5, those in Table 2 with a device 1 comprising a Fumasep FKS-30 membrane 5 sold by Fumatech® with a thickness of between 26 and 30 μm and those in Table 3 with a device 1 comprising a NAFION HP membrane 5 sold by Chemours® with a thickness of 22 μm. Regardless of the membrane 5 used, the performance of the device 1 increases and then decreases when the period T exceeds a value between 40 and 60 seconds. Note that this period T depends on the cell 2 used (type of adsorption surface 41, 42, volume of compartments 31, 32, volume of solutions L1, L2, type of solution, nature of ions in solution and of the at least one ion, thickness of membrane 5, type of connectors, etc.). It can also be seen that performance increases as the potential difference E₀ delivered by the generator 7 increases. It may also be noted that increasing the ratio between NaCl concentrations in liquids L1 and L2 beyond a certain threshold induces a drop in the performance of the device 1.

TABLE 1

| | | | | | P_{b-net} | |
|---|---|---|---|---|---|---|
| L1 | L2 | T (s) | E₀ (mV) | Rₘₐₓ (Ω) | (W/m²) | Gain (%) |
| 5.13 | 0.17 | 30 | 0 | 10 | 2.9 | 0 |
| | | | 200 | 30 | 2.3 | −19.8 |
| | | | 550 | 50 | 2.8 | −4.1 |
| | | | 800 | 75 | 3.2 | 11.6 |
| | | 45 | 0 | 12 | 2.3 | 0 |
| | | | 200 | 30 | 3.1 | 34.8 |
| | | | 550 | 50 | 3.3 | 45.4 |
| | | | 800 | 75 | 3.8 | 63.7 |
| | | 60 | 0 | 15 | 1.9 | 0 |
| | | | 200 | 30 | 2.9 | 48.9 |
| | | | 550 | 62 | 3.2 | 61.5 |
| | | | 800 | 75 | 3.2 | 62.6 |
| 5.13 | 0.017 | 45 | 0 | 12 | 3.6 | 0 |
| | | | 200 | 20 | 3.7 | 4.3 |
| | | | 550 | 75 | 4.3 | 20 |
| | | | 800 | 100 | 4.3 | 20.4 |

TABLE 2

| | | | | | P_{b-net} | |
|---|---|---|---|---|---|---|
| L1 | L2 | T (s) | E₀ (mV) | Rₘₐₓ (Ω) | (W/m²) | Gain (%) |
| 5.13 | 0.017 | 45 | 0 | 12 | 3.6 | 0 |
| | | | 200 | 20 | 3.7 | 4.3 |
| | | | 550 | 75 | 4.3 | 20 |
| | | | 800 | 100 | 4.3 | 20.4 |

TABLE 3

| | | | | | P_{b-net} | |
|---|---|---|---|---|---|---|
| L1 | L2 | T (s) | E₀ (mV) | Rₘₐₓ (Ω) | (W/m²) | Gain (%) |
| 5.13 | 0.017 | 45 | 0 | 12 | 3.6 | 0 |
| | | | 200 | 20 | 3.7 | 4.3 |
| | | | 550 | 75 | 4.3 | 20 |
| | | | 800 | 100 | 4.3 | 20.4 |

FIG. 5 shows a histogram showing the net power densities P_{nb} supplied by cell 2 alone, that is for zero potential difference E₀, that is in the absence of generator 7, and the net power densities P_{b-net} supplied by the device 1 for potential differences E₀ delivered by generator 7 of 200, 550 and 800 mV. The external resistor R_{load} that gave optimum results, denoted Rₘₐₓ, was used. Measurements were carried out with each of the membranes 5: FKS-30, Nafion 117 and Nafion HP. For each E₀ a resistance range from 0.1 to 300Ω was tested.

In the case of device 1 with the FKS-30 membrane 5, the open-circuit potential E_{ocv} of cell 2 and the cell resistance R_{cell} are 157 mV and 6.08Ω respectively. A net power density P_{b-net} supplied by device 1 is 4.01 W·m⁻² for an optimum resistance Rₘₐₓ of 75Ω. The net power density P_{b-net} supplied by device 1 corresponds to a 45% increase over the net power density P_{nb} of 2.75 W·m⁻² supplied by the cell 2.

In the case of device 1 with the Nafion HP membrane 5, the open-circuit potential E_{ocv} of the cell 2 and the resistance R_{cell} of the cell 2 are 158 mV and 4.92Ω respectively. These values are slightly better than those displayed by membrane 5 FKS-30 and are much better than those of Nafion 117 for which the open-circuit potential E_{ocv} of the cell 2 is 145 mV and the cell 2 resistance R_{cell} varies between 5.4 and 6Ω. For the Nation HP membrane 5, the best results are obtained for an optimum resistance Rₘₐₓ of 50Ω. A net power density P_{b-net} of 5.26 W·m⁻² was delivered by device 1, corresponding to a 59.8% increase over the net power density P_{nb} delivered by cell 2.

The best results obtained for device 1 comprising the Nafion HP membrane 5 are due to the high selectivity and low resistance of this membrane 5 compared with those of the FKS-30 and NAFION 117 membranes 5. The Nafion 117 membrane 5 has a thickness of 183 μm, compared with 22 μm for Nafion HP and 26-30 μm for the FKS-30 membrane 5.

In the first embodiment, it should be noted that the carbon felt adsorption surfaces 41, 42 used are not selective to a predetermined type of ion. Also, the use of adsorption surfaces 41, 42 selective to cations or anions for example, or even more advantageously to a predetermined type of cation or anion, for example sodium ions Na⁺, would further increase the performance of device 1.

In a second, non-limiting embodiment, the solutions used to show the operation and performance of device 1 according to the invention are an aqueous solution, for example L1, of sodium hydrogen carbonate NaHCO₃ at a concentration of 1 mol/L at a pH of 7.9 and an aqueous solution, for example L2, of sodium carbonate Na₂CO₃ at 0.5 mol/L at a pH of 11.64. Solutions L1 and L2 therefore have different concentrations of hydronium ions H₃O⁺. The operation of the device 1 is therefore, as with the first embodiment, based on a difference in concentration of a predetermined ion, hydronium ions in the case of the second embodiment, between the two liquids L1, L2. According to this second embodiment, in practice and in the targeted applications, it is envisaged to exploit CO₂, for example the CO₂ emitted by gases produced during the combustion of fossil fuels or the CO₂-rich waste gases emitted by industrial, agri-food or agricultural activities. Also, according to the non-limiting embodiment, the pH difference is obtained by injecting CO₂, by bubbling, into one of the compartments 31, 32 containing a Na₂CO₃ and/or NaHCO₃ solution so as to lower the pH and induce a pH difference between the two compartments 31, 32. It is also possible to use other ion concentrations in the L1 and L2 solutions, other L1 and L2 solutions and/or other L1/L2 solution couples (inducing different pH values and pH differences) such as, by way of non-limiting example, the K₂CO₃/KHCO₃ couple or the Na₂HPO₄/NaH₂PO₄ couple. It should be noted that, alternatively, the pH difference can be induced by increasing the temperature of the solution L1, L2 contained in one of the compartments 31, 32, for example by injecting into one of the compartments, for example compartment 31, a solution, for example L1, having a higher temperature than the other solution, or by heating the compartment, for example 31, to increase the temperature of the solution, for example L1, contained therein.

According to the second embodiment, the cell 2 and device 1 are structurally identical to those described in the first embodiment. The cell 2 operates in the same way, periodically recovering a current by successive, alternating injections and withdrawals of liquids L1, L2 into compartments 31, 32. Thus, the parameters and operating parameters of cell 2 and device 1 not described for the second embodiment are identical to those previously described. The adsorption surfaces 41, 42 have a geometric area of approximately 10.1 cm². The apparent surface area of membrane 5 is approximately 5.5 cm². The thickness of membrane 5 is approximately 0.3 mm. The injection rate of liquids L1, L2 into circuits 91, 92 is of the order of 15 mL/min. The volume of compartments 31, 32 is approximately 0.165 cm³.

The porous membrane 5 used is a non-selective membrane 5, model Celgard 3501, sold by the Celgard® company, with a thickness of 25 μm in its dry form and a pore size of 0.064 μm. The injection rate of liquids L1, L2 into circuits 91, 92, that is the filling rate, is 15 mb/min according to the embodiment. The duration of the period T of such a cell 2 was observed to be 60 seconds.

The adsorption surfaces 41, 42 are made of composite material and have a geometric surface area of approximately 10.15 cm². The composite adsorption surfaces 41, 42 act as capacitive electrodes. According to the non-limiting embodiment, the composite adsorption surfaces 41, 42 are made of carbon felt coated with particles having an average size of 200 μm. The particles comprise 70% by weight of manganese (IV) oxide or manganese dioxide MnO₂ particles, 20% by weight of carbon black and 10% by weight of polyvinylidene fluoride. The particle mass load is approximately 12.4 mg/cm².

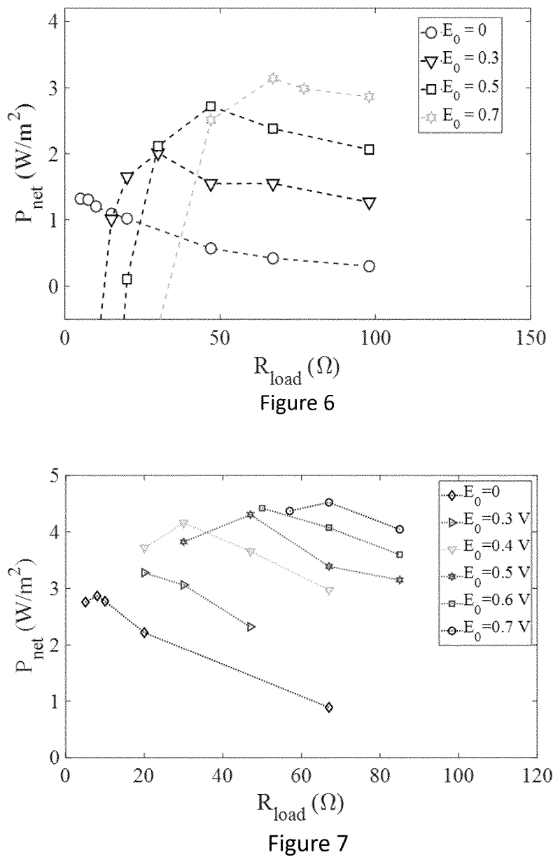

FIG. 6 shows the net power densities P_{nb} supplied by cell 2 alone, that is for zero potential difference E₀, that is in the absence of generator 7, and the net power densities P_{b-net} supplied by the device 1 for potential differences E₀ delivered by generator 7 of 300, 500 and 700 mV. The ph gradient is 2.4. The net power densities P_{nb} supplied by cell 2 alone and the net power densities P_{b-net} supplied by device 1 are shown as a function of the load resistance R_{load} used. As with the first embodiment, it can be seen that device 1 delivers higher net power densities P_{b-net} than the net power densities P_{nb} delivered by cell 2 alone, whatever the load resistance R_{load} used and whatever the potential difference E₀ delivered by generator 7.

FIG. 7 shows the net power densities P_{nb} supplied by cell 2 alone, that is for zero potential difference E₀, in other words in the absence of generator 7, and the net power densities P_{b-net} supplied by the device 1 for potential differences E₀ delivered by generator 7 of 300, 400, 500, 600 and 700 mV. The ph gradient is 3.75. The net power densities P_{nb} supplied by cell 2 alone and the net power densities P_{b-net} supplied by device 1 are shown as a function of the load resistance R_{load} used. Only the optimum resistance range Rₘₐₓ has been plotted on FIG. 7 for each potential difference E₀ delivered by generator 7. As with FIG. 6 and for the first embodiment, it can be seen that device 1 delivers higher net power densities P_{b-net} than the net power densities P_{nb} delivered by cell 2 alone, whatever the load resistance R_{load} used and whatever the potential difference E₀ delivered by generator 7.

Note that the Celgard 3501 membrane 5 used in the second embodiment is a non-selective membrane 5. The use of such a non-selective membrane 5 greatly reduces the performance of the device 1. Also, the use of a selective membrane, for example a cation-selective membrane, even more preferred for hydronium ions, such as a proton exchange membrane, or, for example an anion-selective membrane, even more preferred for hydroxide ions, would significantly increase the performance of the device 1.

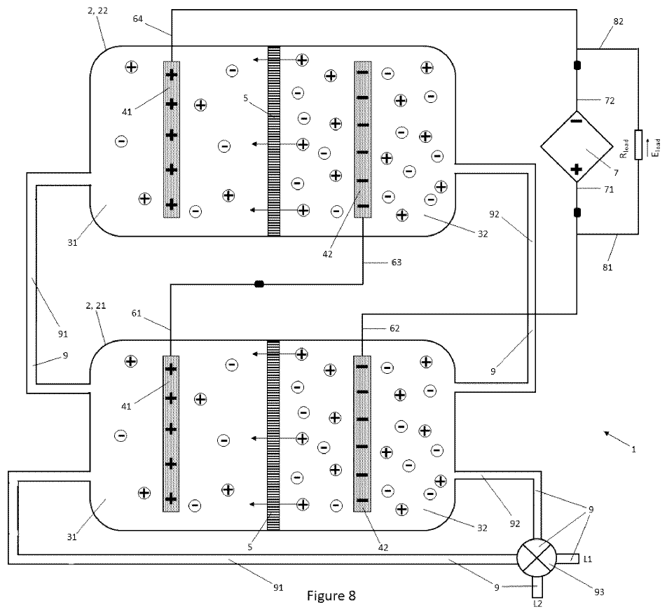

Referring to FIG. 8, and in an improvement to the device 1 according to the first embodiment, a device 1 is proposed comprising two cells 2, 21, 22 connected in series and a voltage generator 7. The terminal 61 of cell 2, 21 is connected to terminal 63 of cell 2, 23. The generator 7 comprises two terminals 71, 72, of which one terminal 71 is connected to terminal 62 of cell 2, 21 and the other terminal 82 is connected to terminal 64 of cell 2, 22. The generator 7 is arranged to deliver a potential difference E₀ between its two terminals 71, 72. The device 1 comprises two terminals 81, 82. The terminal 82 of the device 1 is connected to terminal 64 of cell 2, 21 and to terminal 72 of generator 7. The other terminal 81 of the device 1 is connected to terminal 62 of cell 2, 22 and to terminal 72 of generator 7. The generator 7 is arranged to deliver a non-zero potential difference E₀ between its two terminals 71, 72. It should be noted that this improvement applies to all types of cell 2 and liquids L1, L2 according to the invention. This improvement is also applicable, for example, to the second embodiment.

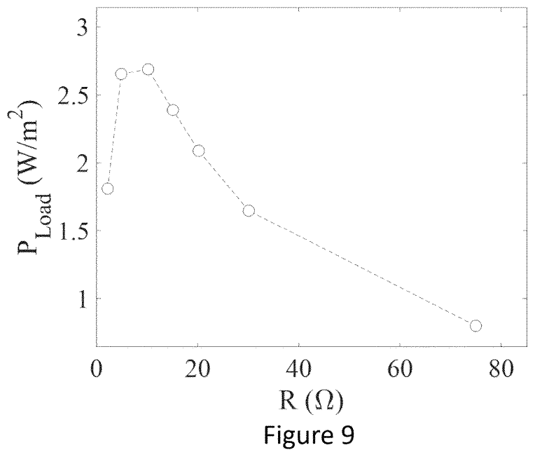

Referring to FIG. 9, and according to the improvement of device 1 as shown in FIG. 8, the net power density P_{b-net} of device 1 is shown as a function of load resistance R_{load} for a voltage E₀ delivered by generator 7 of 0 mV. The potential difference E_{ocv} measured between terminals 81, 82 of device 1, or between terminal 64 of cell 2, 22 and terminal 62 of cell 2, 21, in the presence of the respective liquids L1, L2 in the two compartments 31, 32 is 850 mV, that is 70 mV less than the sum of the potential differences E_{ocv} measured at terminals 61, 62 and 63, 64 of the two cells 2, 21 and 2, 22 taken individually. In addition, the net power values P_{b-net} of device 1 are about 10% lower than the sum of the net powers P_{b-net} of the respective devices 1, each comprising an individual cell 2 of the two cells 2, 21, 22. This difference is due to the fact that the concentration of the solutions L1, L2 entering their respective compartments 31, 32 of the cell 2, 22 changes slightly after passing through their respective compartments 31, 32 of the cell 2, 21. Furthermore, a simple modification of the supply means 9 so that the liquids L1, L2 are injected in parallel directly into the compartments 31, 32 of cells 2, 21 and 2, 22 would avoid the observed loss.

For each embodiment, it is observed that increasing the potential difference E₀ delivered by generator 7 significantly increases the performance of device 1 compared with that of cell 2 alone. In particular, increasing the potential difference E₀ delivered by generator 7 significantly increases the usable load resistance R_{load}. Furthermore, according to the invention, it is advantageous to increase the potential difference E₀ delivered by generator 7 as the load resistance R_{load} increases. We also note that for a given cell 2 and type of liquid L1, L2 used, the potential difference E₀ delivered by generator 7 has an optimum range depending on the load resistor R_{load} used.

Of course, the invention is not limited to the examples just described, and many adjustments can be made to these examples without going beyond the scope of the invention.

In this way, it is possible to combine the various variants and improvements of the previously described embodiments.

Additionally, the various features, forms, variants and embodiments of the invention may be combined with each other in various combinations as long as they are not incompatible or exclusive of each other.

1.-13. (canceled)

14. A device for producing electricity, said device, comprising:
a cell, said cell comprises two compartments, each compartment comprises an adsorption surface for a predetermined ion and said two compartments are separated by a membrane porous to at least the predetermined ion;
said two compartments are each intended to receive a liquid (L1, L2) having a different concentration of the predetermined ion, said cell comprises two terminals respectively connected to the adsorption surfaces of the two compartments and is adapted to generate a potential difference E_{ocv} between its two terminals in the presence of the respective liquids in the two compartments,
a voltage generator, known as the generator, comprising two terminals, one terminal of which is connected to a cell terminal, said generator being arranged to deliver a potential difference E₀ between its two terminals;
the other terminal of the generator constitutes one terminal of the device and the other terminal of the device is constituted by the other terminal of the cell.

15. The device according to claim 14, wherein the terminal of the cell to which the terminal of the generator is connected constitutes the negative polarity terminal of the cell, and wherein the generator is arranged so that said generator terminal connected to the terminal of the cell constitutes the positive polarity terminal of the generator, or vice versa.

16. The device according to claim 14, wherein the adsorption surfaces of the predetermined ion are liquid-porous layers (L1, L2) which are intended to receive the two compartments.

17. The device according to claim 14, wherein each compartment comprises an electrode, an outer surface of which constitutes the adsorption surface for the at least one predetermined ion.

18. The device according to claim 17, wherein the electrode of a compartment, or each electrode of each compartment, is a capacitive electrode.

19. The device according to claim 14, wherein the porous membrane is porous only to the predetermined ion and/or the adsorption surfaces are specific to the predetermined ion.

20. The device according to claim 14, wherein the generator is arranged to deliver a non-zero potential difference E₀ which is less than the absolute value of a redox potential of the liquids (L1, L2) and/or the absolute value of a redox potential of the at least one predetermined ion.

21. The device according to claim 14, wherein the generator is arranged to apply an alternating potential difference E₀.

22. The device according to claim 14, comprising supply means arranged to supply one of the two compartments with liquid (L1) having a concentration C1 of the predetermined ion and the other of the two compartments with liquid (L2) having a concentration C2, lower than C1, of the predetermined ion, and vice versa.

23. The device according to claim 22, wherein the supply means are arranged to supply each of the compartments successively with solutions L1 and L2.

24. The device according to claim 23, wherein a period between two successive supplies of the compartments with liquids (L1, L2) is equal to the period of the alternating potential difference E₀ applied by the generator.

25. The device according to claim 14, comprising at least two cells connected in series.

26. A method for producing electricity comprising the steps of:
generating a potential difference between two terminals of a cell comprising two compartments, from a difference in the concentration of a predetermined ion between two liquids (L1, L2), each contained in one of the respective compartments; each compartment includes an adsorption surface for the predetermined ion, the two terminals of the cell being respectively connected to the adsorption surfaces of the two compartments, and said two compartments being separated by a membrane that is porous to at least the predetermined ion,
applying, by means of a voltage generator, denoted generator, a potential difference E₀ between the two terminals of the generator; one terminal of the generator is connected to one of the two terminals of the cell, while the other terminal of the generator forms one of the two terminals of an electricity-producing device comprising the cell and the generator, the other terminal of the device being formed by the other terminal of the cell.
